(19) United States
(12) Patent Application Publication
(10) Pub. No.: US 2020/0368728 A1
(43) Pub. Date: Nov. 26, 2020

(54) METHOD OF COUPLING METHANE DRY-REFORMING AND COMPOSITE CATALYST REGENERATION

(71) Applicant: ZHEJIANG UNIVERSITY, Zhejiang (CN)

(72) Inventors: Sufang WU, Zhejiang (CN); Jiayan XU, Zhejiang (CN); Hao LIU, Zhejiang (CN); Qirui LIN, Zhejiang (CN); Hui XIAO, Zhejiang (CN)

(73) Assignee: ZHEJIANG UNIVERSITY, Zhejiang (CN)

(21) Appl. No.: 16/344,020

(22) PCT Filed: May 15, 2018
(86) PCT No.: PCT/CN2018/086789

§ 371 Date: Apr. 23, 2019

(30) Foreign Application Priority Data
Mar. 28, 2018 (CN) 201810262083.X

(51) Int. Cl. B01J 23/94; B01J 21/04; B01J 23/78; B01J 38/02; B01J 38/04; C01B 3/40

(52) U.S. Cl. CPC B01J 23/94; B01J 21/04; B01J 23/78; B01J 38/02; C01B 2203/1082; C01B 3/40; C01B 2203/0238; C01B 2203/0425; C01B 2203/1058; B01J 38/04

(57) ABSTRACT

The present invention is related to a method of coupling methane dry-reforming and composite catalyst regeneration. A composite catalyst is filled into a reactor, and methane or a methane mixture gas is introduced therein. CaCO₃ in the composite catalyst is decomposed under 600-850° C. CO₂ obtained by the decomposition reacts with methane to perform methane dry-reforming reaction and produce synthesis gas containing CO and hydrogen. The composite catalyst contains CaCO₃ , active nickel and alumina support. This method couples the CaCO₃ decomposition reaction in calcium looping and methane dry-reforming reaction to solve the technical problem of limiting CaCO₃ decomposition by high-temperature equilibrium. The decomposition of CaCO₃ is enhanced, and the CO₂ produced by decomposing CaCO₃ is dry-reformed to produce synthesis gas to be utilized.

### BACKGROUND

### 1. Field of the Invention

The present invention is related to the field of composite catalyst regeneration, in particular to a method of coupling methane dry-reforming and composite catalyst regeneration.

### 2. Description of Related Arts

Calcium looping refers to the process of the carbonation of calcium oxide by carbon dioxide to form calcium carbonate, and the decomposition of calcium carbonate to produce calcium oxide and carbon dioxide. The research of the calcium looping process is mainly about the study of calcium oxide as a high-temperature carbon dioxide adsorbent. Though a large number of studies focus on the carbonation performance of the adsorbent, the study on calcium carbonate decomposition, an important step in it, is still not in-depth. This is because that people are used to regard calcium carbonate decomposition is a conventional thermal decomposition process using external heating.

Calcium carbonate decomposition is a strong endothermic gas-solid reaction affected by the reaction temperature, equilibrium of pressure, as well as heat and mass transfer, which especially has an important relation with particle size. Florin et al. (N. H. Florin, A. T. Harris. Reactivity of CaO derived from nano-sized CaCO₃ particles through multiple CO₂ capture-and-release cycles[J]. Chem. Eng. Sci., 2009, 64(2):187-191.) studied decomposition performance of nano CaCO₃ with the particle size of 40 nm and arrived at a conclusion that conversion ratio of calcination decomposition reaction of nano CaCO₃ was increased by 1.5 times as compared with that of calcination decomposition reaction of CaCO₃ at the micron level. Luo et al. (C. Luo, et al. Morphological changes of pure micro- and nano-sized CaCO₃ during a calcium looping cycle for CO₂ capture[J]. Chem. Eng. & Technol., 2012, 35(3):547-554.) studied and compared microscopic structure changes of micron- and nano-sized calcium oxide in the calcium looping. Wu et al. (S. F. Wu, Q. H. Li, J. N. Kim. Properties of a nano CaO/Al₂O₃ CO₂ sorbent[J]. Ind. Eng. Chem. Res., 2008, 47(1):180-184.) carried out experiments to compare the CO₂ absorption rate of CaO obtained by decomposing 70 nm and 80 μm CaCO₃ particles. In the temperature range of 500-650° C., the reaction rate and final conversion rate of nano-scale calcium oxide were significantly higher than those of the micro-scale calcium oxide. Meanwhile, the measured decomposition temperature of nano calcium carbonate was reduced by 200° C. as compared with that of the general micron-sized calcium carbonate used in industry. Although the above-mentioned research uses nano-scale calcium oxide, the carbonation reaction and the decomposition performance of nano-calcium carbonate are greatly improved compared with micro-scale calcium oxide. However, since the decomposition of nano calcium carbonate is limited by the equilibrium of the decomposition reaction, the high temperature is required by the decomposition and the problem of high energy consumption still exists, on one hand. On the other hand, the decomposition rate is low affected by heat supply efficiency. Moreover, the utilization of CO₂ produced by decomposition of CaCO₃ is also an unresolved and important issue.

There are also many studies in the prior art for the application of a nickel-based catalyst to a dry reforming reaction of methane and carbon dioxide. Abdullah et al. (B. Abdullah, N. A. A. Ghani, Dai-Viet N. Vo. Recent advances in dry reforming of methane over Ni-based catalysts[J]. J. Cleaner Prod., 2017, 162:170-185.) discovered that the nickel-based catalyst was deactivated due to sintering of nickel-based catalyst and carbon deposits on surface thereof under high-temperature conditions, which has plagued the nickel-based catalyst in the dry reforming reaction of methane and carbon dioxide.

### SUMMARY

The present invention provides a method of coupling methane dry-reforming and composite catalyst regeneration in view of deficiencies of prior arts. Since composite catalyst contains CaCO₃, the decomposition reaction of calcium carbonate in the calcium looping is coupled with the dry reforming of methane. Therefore, the technical problem that CaCO₃ decomposition limited by high temperature equilibrium is resolved. The calcium carbonate decomposition is thus enhanced, as well as the purpose of utilizing the carbon dioxide, produced by calcium carbonate decomposition, in dry reforming to form synthesis gas is achieved.

Technical solution provided by the present invention is stated as follows:

In a method of coupling methane dry-reforming and composite catalyst regeneration, a composite catalyst is filled into a reactor. A methane mixture gas is introduced. CaCO₃ in the composite catalyst is decomposed at 600-850° C. CO₂ obtained by the decomposition reaction is reacted with methane to perform a dry reforming reaction to form synthesis gas of CO and H₂. The composite catalyst comprises CaCO₃, active nickel and alumina support.

As shown in FIG. 1, calcium carbonate in particles of the composite catalyst is first thermally decomposed by heat; see Equation (1). The CO₂ produced by the reaction and the introduced methane are adsorbed on the surface of the active nickel component to perform in-situ dry-reforming methane (DRM) for generating carbon monoxide and hydrogen, namely synthesis gas; see Equation (2).

CaCO₃⇄CaO+CO₂ ΔH_{298K}=178kJ/mol (1)

CH₄+CO₂⇄2CO+2H₂ ΔH_{298K}=247kJ/mol (2)

Due to the in-situ dry reforming of methane, CO₂ concentration around the calcium carbonate in the composite catalyst is reduced. According to Le Chatelier's principle, the equilibrium of the calcium carbonate reaction is shifted to the side of calcium oxide generation to enhance the calcium carbonate decomposition. Therefore, the temperature at which decomposition reactions may occur is reduced, the decomposition time is shortened, and the decomposition efficiency is improved.

Methane and CO₂ are two different greenhouse gases that may produce synthesis gas with a 1:1 ratio of carbon monoxide and hydrogen. The synthesis gas can be directly used to synthesize methanol by Fischer-Tropsch process, or other useful chemical products and fuels such as hydrocarbons. Furthermore, dry-reforming synthesis gas consumes almost no water. Make heavy use of carbon dioxide and reduce energy consumption can alleviate the pressure of greenhouse gas emission.

According to the present invention, the composite catalyst component is calculated by CaO, NiO and Al₂O₃, respectively, and the mass ratio of each components in the composite catalyst is CaO:NiO:Al₂O₃=2-7:1:1.0-3.5.

Formation of carbon deposit in the dry-reforming methane is mainly incurred by CH₄ decomposition and CO disproportionation. Active nickel has catalytic activity to CH₄ decomposition and CO disproportionation. Thermal decomposition of CaCO₃ in the composite catalyst generate CaO. The presence of CaO increase the alkalinity of the composite catalyst to inhibit methane decomposition and CO disproportionation. In addition, in this technical solution, due to the coupling of the calcium carbonate decomposition reaction and the dry reforming of methane, the decomposition temperature of the calcium carbonate is reduced. Therefore, the deposition rate of carbon generated by methane decomposition is decreased to inhibit the carbon deposit. CaO and the active nickel are existed in the particles of the same composite catalyst. CO₂ is produced by calcium carbonate decomposition and CO₂ may be directly adsorbed by the active nickel in the composite catalyst, thus decrease the diffusion of CO₂ to perform in-situ dry reforming of methane to improve catalytic effect.

According to the present invention, the methane mixture gas may be natural gas or industrial gases mainly comprising methane, such as coke oven gas, biogas and so on. Preferably, the methane mixture gas is a mixture of methane and one or more of water vapor, carbon dioxide, and nitrogen.

According to the present invention, the volume ratio of methane in the methane mixture gas is not less than 10%.

According to the present invention, the decomposition pressure of the decomposition reaction is 0.1-3.0 MPa, and the gas space velocity is 100-1000 This reaction condition can realize the decomposition of CaCO₃ in the composite catalyst and the dry reforming of CO₂ and methane.

According to the present invention, CaCO₃ in the composite catalyst is on the order of nanometer or micrometer.

According to the present invention, the reactor comprises a fixed bed, a fluidized bed, a moving bed or a bubbling bed.

According to the present invention, the composite catalyst comprises CaO-CaCO₃, active nickel component and alumina-calcium aluminate support. Since the composite catalyst is always in the calcium looping process, the composite catalyst may comprise CaO and CaCO₃ simultaneously. In the mixing state, the regeneration method may be used by coupling methane dry-reforming with composite catalyst . Moreover, calcium oxide may react with alumina to generate calcium aluminate under high temperature. Therefore, in the reaction process, the support is alumina-calcium aluminate support.

According to the present invention, the composite catalyst has been disclosed by Chinese Invention Patent ZL200610052788.6.

The composite catalyst according to the present invention can be obtained by the following preparation method, mainly comprising the following steps:

(1) The aqueous solution of Ni(NO₃)₂ and CO(NH₂)₂ are mixed, and polyethylene glycol is added for reaction in 60-90° C. water bath. After separating and washing, Ni(OH)₂ is obtained. Preferably, molar concentration ratio of Ni(NO₃)₂ and CO(NH₂)₂ in aqueous solution is 1:2-1:4. The water bath temperature is 60-90° C.

(2) Ni(OH)₂ and nano calcium carbonate are dispersed in the ethanol aqueous solution, and aluminum sol is added to be stirred and mixed. After drying, the product is calcined for 3 h under 450-550° C., and decomposed under 750-850° C. to prepare the composite catalyst of NiO—CaO/Al₂O₃.

According to the present invention, the composite catalyst is from the catalyst of the methane steam reforming reaction after adsorbing CO₂. After adsorbing CO₂ in the methane steam reforming, calcium oxide in the catalyst is converted to calcium carbonate.

According to the present invention, the composite catalyst is from the adsorbent containing nickel and calcium oxide for absorbing the flue gas. CaO in the adsorbent becomes calcium carbonate by adsorbing CO₂ in the flue gas.

According to the present invention, the composite catalyst is to be further used for methane steam reforming or decarburization of flue gas after the coupling of methane dry-reforming and composite catalyst regeneration. The technical solution enables the composite catalyst to be recycled.

Compared with prior arts, the present invention has the following beneficial effects:

(1) The present invention uses the composite catalyst to couple the methane dry reforming and the calcium carbonation decomposition, thereby not only lowering the decomposition temperature of calcium carbonate, increasing the decomposition rate of calcium carbonate, but also shortening the decomposition reaction time. Furthermore, the CO₂ produced by calcium carbonate decomposition is converted to carbon monoxide and hydrogen in situ by using methane dry reforming.

(2) The composite catalyst used in the present invention produces a large amount of CaO in the methane dry reforming as an auxiliary agent for the active nickel component. Due to the presence of calcium oxide, the basicity of the nickel catalyst is greatly enhanced, thereby reducing the carbon deposition produced by the side reaction and avoiding the deactivation of the composite catalyst.

### BRIEF DESCRIPTION OF THE DRAWINGS

FIG. 1 is a schematic diagram showing the principle of the calcium looping that couples methane dry-reforming and composite catalyst regeneration.

FIG. 2 is the schematic diagram showing the principle of the reactive sorption enhanced reforming (ReSER) hydrogen production process that couples methane dry-reforming and composite catalyst regeneration.

### DESCRIPTION OF THE EMBODIMENTS

The present invention is further described as follows in combination with preferred embodiments. However, the present invention is not limited to the following embodiments.

### Embodiment 1: Preparation of the Composite Catalyst

(1) 350 mL of a mixed aqueous solution containing Ni(NO₃)₂ and CO(NH₂)₂ having molar concentrations of 0.236 mol/L and 0.945 mol/L, respectively, were prepared. 6.76 g of polyethylene glycol was added to react in a 90° C. water bath for a period of time and then is cooled to room temperature. Deionized water and absolute ethyl alcohol were used to wash the product for several times until neutral to obtain Ni(OH)₂.

(2) 3.14 g Ni(OH)₂ prepared in Step (1) and 11.30 g nano calcium carbonate were dispersed in an ethanol aqueous solution and ultrasonically dispersed for 10 min. 37.95 g alumina sol was then added, mixed thoroughly, dried for overnight under 120° C., calcined under 500° C. for 3 h, and decomposed under 800° C. for 15 min to obtain the composite catalyst of NiO—CaO/Al₂O₃ having a mass ratio of 2:5:3 for NiO, CaO and Al₂O_{3.}

### Embodiment 2: The Composite Catalyst for ReSER Hydrogen Production

Reaction principles are shown in FIG. 2. The reaction on the left side is ReSER hydrogen production. The composite catalyst of 5 g NiO—CaO/Al₂O₃ prepared in Embodiment 1 was filled into a fixed-bed reactor. A mixed gas of hydrogen and nitrogen was used to reduce NiO in the composite catalyst to Ni. Methane and water steam were introduced into the reactor to produce hydrogen. The flow rate of methane was 20 ml/min. The molar ratio of water over carbon was 5. The temperature was 600° C. The pressure was 0.2 MPa. The composite catalyst NiO—CaO/Al₂O₃ was converted to the composite catalyst NiO—CaCO₃/Al₂O₃ after CO₂ was saturatedly adsorbed by the composite catalyst NiO—CaO/Al₂O_{3.}

### Embodiment 3: The Composite Catalyst for ReSER Hydrogen Production

The composite catalyst of 5 g NiO—CaO/Al₂O₃ prepared in Embodiment 1 was filled into a fixed-bed reactor. A mixed gas of hydrogen and nitrogen was used to reduce NiO in the composite catalyst to Ni. Methane and water steam were introduced into the reactor to produce hydrogen. The flow rate of methane was 20 ml/min. The molar ratio of water over carbon was 4. The temperature was 650° C. The pressure was 0.2 MPa. The composite catalyst NiO—CaO/Al₂O₃ was converted to the composite catalyst NiO—CaCO₃/Al₂O₃ after CO₂ was saturatedly adsorbed by the composite catalyst NiO—CaO/Al₂O_{3.}

### Embodiment 4: The Composite Catalyst for ReSER Hydrogen Production

The composite catalyst of 5 g NiO—CaO/Al₂O₃ prepared in Embodiment 1 was filled into a fixed-bed reactor. A mixed gas of hydrogen and nitrogen was used to reduce NiO in the composite catalyst to Ni. Methane and water steam were introduced into the reactor to produce hydrogen. The flow rate of methane was 30 ml/min. The molar ratio of water over carbon was 3. The temperature was 600° C. The pressure was 0.2 MPa. The composite catalyst NiO—CaO/Al₂O₃ was converted to the composite catalyst NiO—CaCO₃/Al₂O₃ after CO₂ was saturatedly adsorbed by the composite catalyst NiO—CaO/Al₂O_{3.}

### Embodiment 5: The Composite Catalyst Adsorbing CO₂ in Flue Gas

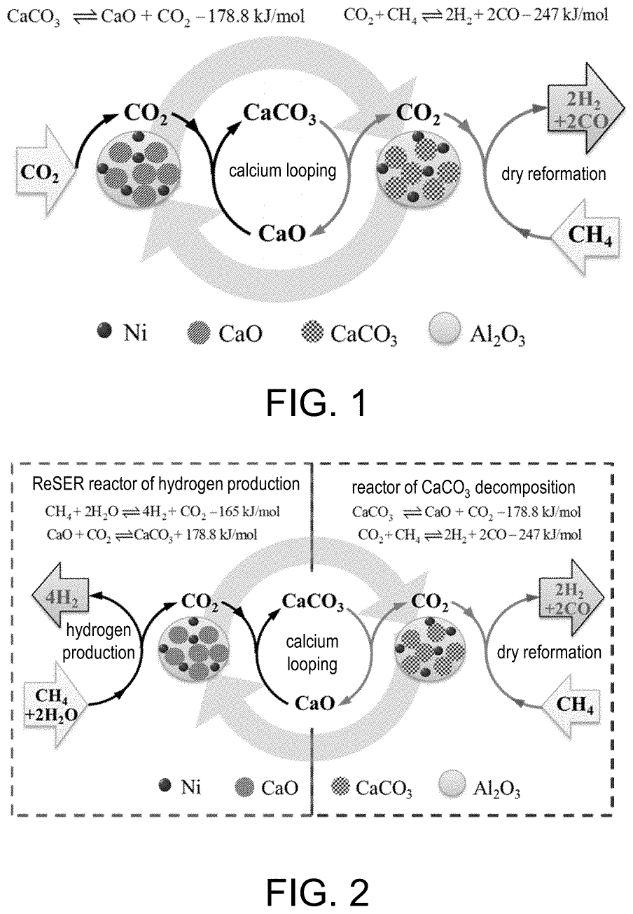

The reaction principles are shown in FIG. 1. The composite catalyst of 5 g NiO—CaO/Al₂O₃ prepared in Embodiment 1 was filled into a fixed-bed reactor. Under a condition of normal pressure and 600° C., 100 mL of nitrogen-simulated mixed flue gas containing 50% CO₂ was introduced into the fixed-bed reactor. The composite catalyst NiO—CaO/Al₂O₃ was converted to the composite catalyst NiO—CaCO₃/Al₂O₃ after CO₂ was saturatedly adsorbed by the composite catalyst NiO—CaO/Al₂O_{3.}

### Embodiment 6: The Composite Catalyst Adsorbing CO₂ in Flue Gas

The composite catalyst of 5 g NiO—CaO/Al₂O₃ prepared in Embodiment 1 was filled into a fixed-bed reactor. Under a condition of normal pressure and 650° C., 100 mL of nitrogen-simulated mixed flue gas containing 10% CO₂ was introduced into the fixed-bed reactor. The composite catalyst NiO—CaO/Al₂O₃ was converted to the composite catalyst NiO—CaCO₃/Al₂O₃ after CO₂ was saturatedly adsorbed by the composite catalyst NiO—CaO/Al₂O_{3.}

### Embodiment 7: Coupling of Methane Dry-Reforming and Composite Catalyst Regeneration

The reaction principles are shown on the right side of FIG. 2. The composite catalyst of 5 g NiO—CaO/Al₂O₃, after saturated adsorption in Embodiment 3, was filled into a fixed-bed reactor. Methane and nitrogen were introduced into the fixed-be reactor to perform reaction. The gas space velocity was 800 h⁻¹. The decomposition temperature was 800° C. The flow rate of methane was 5 mL/min. The flow rate of nitrogen was 495 mL/min. The decomposition pressure was 0.1 MPa. The complete decomposition time calcium carbonate was 35 minutes. The conversion rate of methane was 88%. The conversion rate of carbon dioxide was 81%.

A carbon deposit test was performed for the composite catalyst regenerated in Embodiment 7 on a thermogravimetric analyzer (TGA). Testing method is stated as follows: About 2 mg of samples were filled into a special platinum crucible for dewatering for 30 min under 150° C. Then, the temperature was increased to 800° C. at a rate of 15° C./min under a nitrogen atmosphere to completely decompose the calcium carbonate in the composite catalyst.

After changing to an air atmosphere, the catalyst was calcined for 30 minutes. The carbon deposit ratio was calculated by the mass difference of the catalyst before and after the reaction. The calculation formula of the carbon deposit ratio is stated below:

Carbon deposit ratio=Ma/Mb−Ma

Mb is the mass of the composite catalyst before calcination, and Ma is the mass of the composite catalyst after calcination. The carbon deposit ratio in Embodiment 7 was calculated to be 15.08%.

### Embodiment 8-14: Coupling of Methane Dry-Reforming and Composite Catalyst Regeneration

The composite catalyst of NiO—CaO/Al₂O₃, after saturated adsorption in Embodiment 3 was filled into a fixed-bed reactor. The reaction conditions are shown in Table 1.

TABLE 1
Reaction Conditions and Results in Embodiment 8-14

| | | | | | | Calcium | | | |
|---|---|---|---|---|---|---|---|---|---|
| | | | | Air | | carbonate | Methane | CO₂ | Carbon |
| | Reaction | Methane | Nitrogen | space | Reaction | decomposition | conversion | conversion | deposition |
| Embodiment | temperature | flow rate | flow rate | velocity | pressure | time | rate | rate | ratio |
| 8 | 800 | 50 | 50 | 600 | 0.1 | 12 | 94 | 85 | 16.1% |
| 9 | 800 | 25 | 75 | 800 | 0.1 | 18 | 86 | 80 | 13.3% |
| 10 | 600 | 25 | 75 | 500 | 0.1 | 30 | 70 | 50 | 1.5% |
| 11 | 750 | 10 | 90 | 100 | 1.5 | 28 | 89 | 80 | 2.4% |
| 12 | 850 | 10 | 90 | 300 | 1 | 15 | 92 | 65 | 14.4% |
| 13 | 800 | 100 | 0 | 1000 | 0.15 | 18 | 90 | 60 | 25.6% |
| 14 | 800 | 100 | 0 | 1000 | 0.15 | 18 | 93.6 | 70 | 24.4% |

From Table 1, it can be seen that the coupling of calcium carbonate decomposition in the composite catalyst with methane dry reforming can solve the technical problem of limiting CaCO₃ decomposition by high-temperature equilibrium. Thus, the conversion rates of methane and CO₂ were increased; the calcium carbonate decomposition time was shortened; and the temperature of calcium carbonate was reduced. Moreover, the carbon deposit ratio was further decreased.

1-10. (canceled)

11. A method of coupling methane dry-reforming and composite catalyst regeneration, comprising:
filling a first composite catalyst into a reactor, wherein the first composite catalyst comprises CaCO₃ and an active nickel containing NiO supported on a support containing alumina (Al₂O₃);
introducing a methane-containing gas into the reactor;
decomposing the CaCO₃ in the first composite catalyst at 600-850° C. to obtain CO₂ and CaO; and
performing methane dry reforming reaction by reacting the obtained CO₂ with methane in the methane-containing gas to form synthesis gas containing CO and H₂.

12. The method of claim 11, wherein a mass ratio of CaO, NiO and Al₂O₃ in the first composite catalyst is 2-7:1:1.0-3.5.

13. The method of claim 11, wherein the methane-containing gas is methane, or a mixture of methane and at least one of water vapor, CO₂ and nitrogen.

14. The method of claim 11, wherein a volume ratio of the methane in the methane-containing gas is at least 10%.

15. The method of claim 11, wherein the decomposing step is performed under a pressure of 0.1-3.0 MPa, and a gas space velocity is 100-1000 h⁻¹.

16. The method of claim 11, wherein the alumina of the support reacts with the CaO obtained in the decomposing step to form calcium aluminate.

17. The method of claim 11, wherein the reactor comprises a fixed bed reactor, a fluidized bed reactor, a moving bed reactor or a bubbling bed reactor.

18. The method of claim 11, wherein the first composite catalyst is prepared by a second composite catalyst adsorbing CO₂ from methane steam reforming reaction, and the second composite catalyst comprises alumina-supported CaO and NiO.

19. The method of claim 18, further comprising performing the steps of filling the first composite catalyst into the reactor, introducing the methane-containing gas into the reactor, decomposing the CaCO₃ in the first composite catalyst, and performing the methane dry reforming reaction in claim 1.

20. The method of claim 11, wherein the first composite catalyst is prepared by a second composite catalyst adsorbing CO₂ from flue gas decarburization process, and the second composite catalyst comprises alumina-supported CaO and NiO.

21. The method of claim 20, further comprising performing the steps of filling the first composite catalyst into the reactor, introducing the methane-containing gas into the reactor, decomposing the CaCO₃ in the first composite catalyst, and performing the methane dry reforming reaction in claim 1.
